(19) United States
(12) Patent Application Publication
(10) Pub. No.: US 2023/0394292 A1
(43) Pub. Date: Dec. 7, 2023

(54) METHOD AND APPARATUS FOR SYNCHRONIZING NEUROMORPHIC PROCESSING UNITS

(71) Applicant: ELECTRONICS AND TELECOMMUNICATIONS RESEARCH INSTITUTE, Daejeon (KR)

(72) Inventors: Youngmok HA, Daejeon (KR); Eunji PAK, Daejeon (KR); Yongjoo KIM, Sejong-si (KR); Taeho KIM, Daejeon (KR)

(73) Assignee: ELECTRONICS AND TELECOMMUNICATIONS RESEARCH INSTITUTE, Daejeon (KR)

(21) Appl. No.: 18/077,116

(22) Filed: Dec. 7, 2022

(30) Foreign Application Priority Data
Jun. 7, 2022 (KR) 10-2022-0068791

(51) Int. Cl. G06N 3/063; G06N 3/04

(52) U.S. Cl. CPC G06N 3/063; G06N 3/0454

(57) ABSTRACT

Disclosed herein are a method and apparatus for synchronizing neuromorphic processing units. The method for synchronizing neuromorphic processing units includes calculating a time length maximizing a likelihood probability distribution or a posterior probability distribution based on a multi-dimensional variable influencing a change in a time length used by a neuromorphic processing unit to perform an operation, generating a lookup table based on the multi-dimensional variable and the time length maximizing the likelihood probability distribution or the posterior probability distribution for the multi-dimensional variable, and updating the lookup table based on the time length used by the neuromorphic processing unit to perform the operation and the time length maximizing the likelihood probability distribution or the posterior probability distribution.

### CROSS REFERENCE TO RELATED APPLICATION

This application claims the benefit of Korean Patent Application No. 10-2022-0068791, filed Jun. 7, 2022, which is hereby incorporated by reference in its entirety into this application.

### BACKGROUND OF THE INVENTION

### 1. Technical Field

The present disclosure relates generally to technology for synchronizing the operations of processing units constituting neuromorphic hardware.

### 2. Description of the Related Art

Generally, a neuromorphic processing unit (NPU) is a processing unit included in neuromorphic hardware for processing neuron/synapse information generated in a neuromorphic artificial neural network.

The neuromorphic artificial neural network refers to an artificial neural network which imitates a brain neural network based on computational neuroscience discovery. In the neuromorphic artificial neural network, a neuron is composed of using dendrites, somas, etc., a differential equation (e.g., Leaky Integrate-and-Fire, Izhikevich, Hodgkin-Huxley equation) including a time variable is adopted to the design of the operations of neurons/synapses, and then a binary spike imitating an electrical signal is used for the transmission of information between neurons.

The synchronization of neuromorphic processing units is technology required in order to allow data processing corresponding to a neuromorphic artificial neural network installed in neuromorphic hardware to be completely performed by multiple NPUs in the neuromorphic hardware.

The synchronization of neuromorphic processing units (NPUs) refers to a process of determining a neural-network clock tick (NCT) so that multiple NPUs in the neuromorphic hardware share the same time concept with each other, and allowing the multiple NPUs to use the determined NCT.

Conventional synchronization of NPUs may roughly include two types. A first type is a scheme for allowing all NPUs to share a time length between fixed neural-network clock ticks (NCTs) with each other. A second type is a scheme for allowing all NPUs to share a time length between variable NCTs with each other.

The scheme using the time length between fixed NCTs incurs loss from the standpoint of performance and efficiency because the time required for the operations of NPUs and the transmission of output data varies per tick depending on the states of NPUs (e.g., the amount of input data, a neuron state variable value, a connection structure between NPUs, or the like), a method for exchanging data between NPUs, a policy, or the like.

The scheme for adopting the time length between variable NCTs is disadvantageous in that, whenever an NCT value increases, the exchange of a barrier synchronization message between NPUs is performed, with the result that a communication load increases.

### SUMMARY OF THE INVENTION

Accordingly, the present disclosure has been made keeping in mind the above problems occurring in the prior art, and an object of the present disclosure is to provide a method and apparatus for synchronizing neuromorphic processing units (NPUs), which can efficiently determine a time length between neural-network clock ticks (NCTs) that may vary depending on the states of NPUs and data distribution.

In accordance with an aspect of the present disclosure to accomplish the above object, there is provided a method for synchronizing neuromorphic processing units, including calculating a time length maximizing a likelihood probability distribution or a posterior probability distribution based on a multi-dimensional variable influencing a change in a time length used by a neuromorphic processing unit to perform an operation, generating a lookup table based on the multi-dimensional variable and the time length maximizing the likelihood probability distribution or the posterior probability distribution for the multi-dimensional variable, and updating the lookup table based on the time length used by the neuromorphic processing unit to perform the operation and the time length maximizing the likelihood probability distribution or the posterior probability distribution.

The lookup table may include (θ, Xₑ) pairs formed using a multi-dimensional variable (θ) influencing a change in a time length (Xᵣ) used by the neuromorphic processing unit to complete data processing and exchange and a time length (Xₑ) maximizing a likelihood probability distribution or a posterior probability distribution for the multi-dimensional variable (θ).

The lookup table may include (θₕ, X_{e,h}) pairs formed using a multi-dimensional variable (θₕ) influencing changes in respective time lengths (X_{r,h}) used by multiple neuromorphic processing units to complete sequential multi-step data processing and data exchange and a time length (Xₑ,h) maximizing a likelihood probability distribution or a posterior probability distribution for the multi-dimensional variable (θₕ).

The time length used by the neuromorphic processing unit to perform the operation may be determined to be a sum of respective time lengths (X_{r,h}) used by the multiple neuromorphic processing units to complete sequential multi-step data processing and data exchange.

The lookup table may include a first lookup table including the (θ, Xₑ) pairs and a second lookup table including the (θₕ, X_{e,h}) pairs, and the first and second lookup tables are individually managed by an internal memory or an external memory of each neuromorphic processing unit.

The lookup table may be constructed and updated based on at least one of linear/nonlinear programming, Markov chain Monte-Carlo (MCMC) methodology, Laplace approximation, regression analysis, a random process, an artificial neural network, gradient descent, a Newton method or a Kalman filter, or a combination thereof.

Whether the lookup table is to be updated may be determined based on a difference between the time length used by the neuromorphic processing unit to perform the operation and the time length maximizing the likelihood probability distribution or the posterior probability distribution.

The multi-dimensional variable may include at least one of state information of the neuromorphic processing unit, a method for exchanging data between neuromorphic processing units, or a policy, or a combination thereof.

The state information of the neuromorphic processing unit may include at least one of an amount and a structure of input data, a neuron state variable value or information about a connection structure between neuromorphic processing units, or a combination thereof.

In accordance with another aspect of the present disclosure to accomplish the above object, there is provided an apparatus for synchronizing neuromorphic processing units, including memory configured to store a control program for synchronizing neuromorphic processing units, and a processor configured to execute the control program stored in the memory, wherein the processor is configured to calculate a time length maximizing a likelihood probability distribution or a posterior probability distribution based on a multi-dimensional variable influencing a change in a time length used by a neuromorphic processing unit to perform an operation, generate a lookup table based on the multi-dimensional variable and the time length maximizing the likelihood probability distribution or the posterior probability distribution for the multi-dimensional variable, and update the lookup table based on the time length used by the neuromorphic processing unit to perform the operation and the time length maximizing the likelihood probability distribution or the posterior probability distribution.

The processor may perform control such that (θ, Xₑ) pairs formed using a multi-dimensional variable (θ) influencing a change in a time length (Xᵣ) used by the neuromorphic processing unit to complete data processing and exchange and a time length (Xₑ) maximizing a likelihood probability distribution or a posterior probability distribution for the multi-dimensional variable (θ) are stored in the lookup table.

The processor may perform control such that (θₕ, X_{e,h}) pairs formed using a multi-dimensional variable (θₕ) influencing changes in respective time lengths (X_{r,h}) used by multiple neuromorphic processing units to complete sequential multi-step data processing and data exchange and a time length (X_{e,h}) maximizing a likelihood probability distribution or a posterior probability distribution for the multi-dimensional variable (θₕ) are stored in the lookup table.

The time length used by the neuromorphic processing unit to perform the operation may be determined to be a sum of respective time lengths (X_{r,h}) used by the multiple neuromorphic processing units to complete sequential multi-step data processing and data exchange.

The lookup table may include a first lookup table including the (θ, Xₑ) pairs and a second lookup table including the (θₕ, X_{e,h}) pairs, and the first and second lookup tables are individually managed by an internal memory or an external memory of each neuromorphic processing unit.

The processor may perform control such that the lookup table is constructed and updated based on at least one of linear/nonlinear programming, Markov chain Monte-Carlo (MCMC) methodology, Laplace approximation, regression analysis, a random process, an artificial neural network, gradient descent, a Newton method or a Kalman filter, or a combination thereof.

The processor may determine whether the lookup table is to be updated based on a difference between the time length used by the neuromorphic processing unit to perform the operation and the time length maximizing the likelihood probability distribution or the posterior probability distribution.

The multi-dimensional variable may include at least one of state information of the neuromorphic processing unit, a method for exchanging data between neuromorphic processing units, or a policy, or a combination thereof.

The state information of the neuromorphic processing unit may include at least one of an amount and a structure of input data, a neuron state variable value or information about a connection structure between neuromorphic processing units, or a combination thereof.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating an apparatus for synchronizing neuromorphic processing units according to an embodiment of the present disclosure;

FIG. 2 is a block diagram illustrating the configuration of a neuromorphic processing unit according to an embodiment of the present disclosure;

FIG. 3 is a graph illustrating a relationship between a neural-network clock tick (NCT) and a time to maximum rate (TMR);

FIG. 4 is a flowchart illustrating a method for synchronizing neuromorphic processing units according to an embodiment of the present disclosure;

FIG. 5 is a diagram for explaining the time taken for all NPUs sharing an NCT with each other to complete data processing and exchange, which are to be completed within a single NCT;

FIG. 6 illustrates an example of the configuration of the lookup table of FIG. 5;

FIG. 7 is a diagram for explaining the time taken to complete data processing within a single NCT through sequential multi-step data processing and data exchange performed based on multiple NPUs according to another embodiment;

FIG. 8 illustrates an example of the configuration of the lookup table of FIG. 7; and

FIG. 9 is a block diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Embodiments of the present disclosure will now be described in detail with reference to the accompanying drawings. Like numerals refer to like elements throughout, and overlapping descriptions will be omitted.

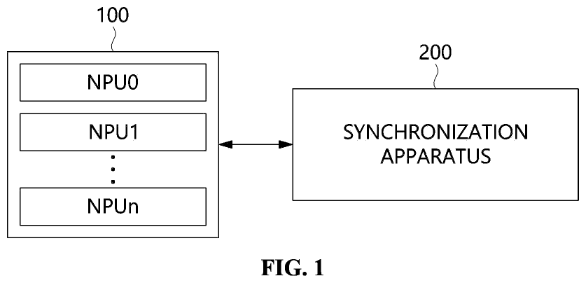

FIG. 1 is a block diagram illustrating an apparatus for synchronizing neuromorphic processing units according to an embodiment of the present disclosure.

As illustrated in FIG. 1, neuromorphic hardware 100 according to an embodiment may include multiple neuromorphic processing units (NPUs). An apparatus 200 for synchronizing neuromorphic processing units (hereinafter also referred to as an “NPU synchronization apparatus 200”) according to an embodiment may perform synchronization so that the multiple NPUs may process data.

For convenience of description, although, in an embodiment, the neuromorphic hardware 100 and the NPU synchronization apparatus 200 are illustrated as separate components, the neuromorphic hardware 100 and the NPU synchronization apparatus 200 may be integrated into a single apparatus.

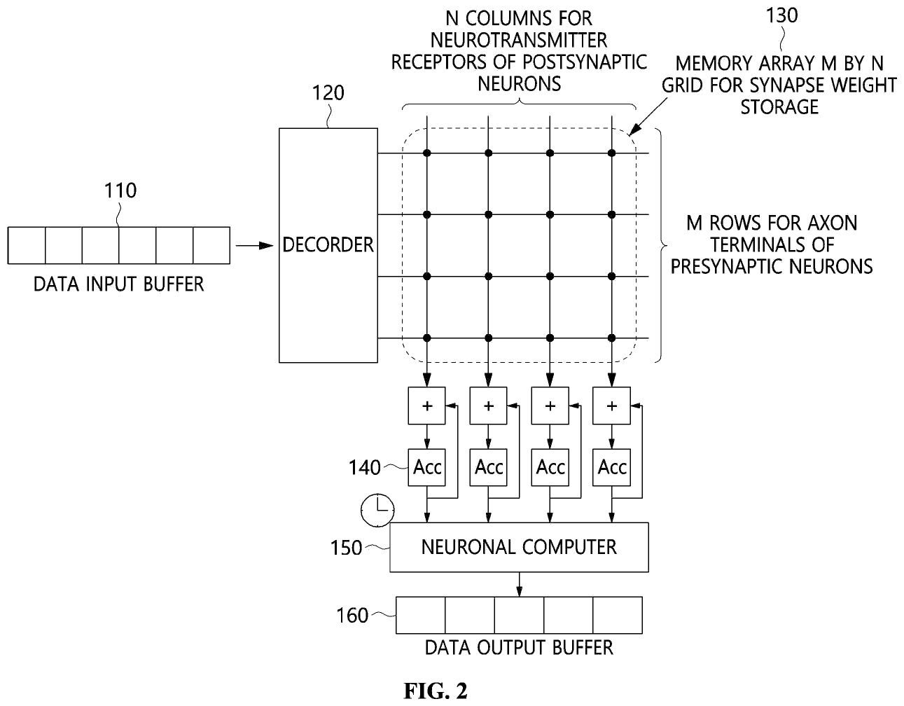

FIG. 2 is a block diagram illustrating the configuration of a neuromorphic processing unit (NPU) according to an embodiment of the present disclosure.

As illustrated in FIG. 2, the neuromorphic processing unit (NPU) according to the embodiment may include a data input buffer 110, a decoder 120, a memory array 130, an addition accumulator 140, a neurodynamics calculator (neuronal computer) 150, and a data output buffer 160.

The data input buffer 110 may include data received from any one neuromorphic processing unit (NPU).

The decoder 120 may decode the data received from the data input buffer 110 so that the data is applied to the memory array 130.

The memory array 130 may store synapse weights in an analog or digital form. The memory array 130 may have an M×N size. The input stage of the memory array 130 (M rows of the array) may abstract M axon terminals of presynaptic neurons. The output stage of the memory array 130 (N columns of the array) may abstract N neurotransmitter receptors of postsynaptic neurons.

The addition accumulator 140 may cumulatively add the synapse weights, stored in the columns of the memory array 130 connected thereto, in an analog or digital manner depending on the input applied to the memory array 130.

The neuronal computer 150 may store state variable values of the receptors of N postsynaptic neurons, and may calculate the state variable values depending on the neuron functions (e.g., Leaky Integrate-and-Fire, Izhikevich, Hodgkin-Huxley, etc.) in which accumulated weights calculated by the addition accumulator 140 and the passage of time are taken into consideration.

The data output buffer 160 may output data to be transferred by the postsynaptic neurons depending on the results of calculation by the neuronal computer 150.

The multiple neuromorphic processing units (NPUs) may be connected in various topologies (e.g., mesh, bus, ring, tree, star, etc.), and may exchange data using various methods (e.g., an electrical signal, a packet, etc.).

The multiple NPUs connected to each other may share a neural-network clock tick (NCT), which is the concept of time to be used by the neuronal computer 150 in each NPU for driving. The NCT may be defined dependently on the value monotonically increasing with time (e.g., a counter value obtained by accumulating the number of clocks applied to each NPU or another module in the hardware) in the neuromorphic hardware 100.

Because the neuronal computer 150 uses a differential equation including a time variable, the neuron state variable values calculated by the neuronal computer 150 may be dependent on the neural network clock tick (NCT). For example, when NCT=T+1 (T≥0), the neuron state variable values calculated by the neuronal computer 150 may be dependent on the neuron state variable values calculated when NCT=T.

The fact that the neuronal computer 150 has NCT dependency may mean that the operation performance and efficiency of the neuromorphic processing units (NPUs) vary with the time length between NCTs or the definition of the NCTs.

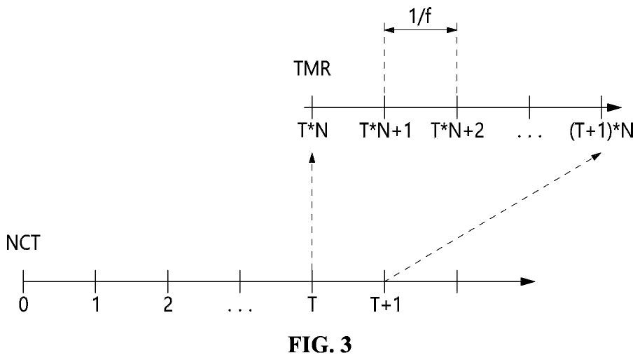

FIG. 3 is a graph illustrating a relationship between NCT and time to maximum rate (TMR).

As illustrated in FIG. 3, it may be assumed that the NCT is defined as a quotient obtained by dividing a counter value TMR (where TMR which is obtained by accumulating the number of clocks having a frequency of f applied to the neuromorphic processing units (NPU), by a positive integer N (where N≥0) for determining NCT granularity and that the time length X represented by one tick of the NCT is X=N/f. In addition, when NCT=T+1, it may be assumed that the time required by the neuromorphic processing units (NPU) to read data input to the data input buffer through a data processing procedure at NCT=T and to perform data processing through the decoder, the memory array, the addition accumulator, the neuronal computer, and the data output buffer is Xₚ (T+1).

In this case, when Xₚ (T+1) satisfies Xₚ (T+1)<X, each neuromorphic processing unit (NPU) may incur loss from the standpoint of efficiency such as time and power for time X−Xₚ (T+1). When Xₚ (T+1) satisfies Xₚ (T+1)>X, each neuromorphic processing unit (NPU) may incur an error because processing to be performed when NCT=T+1 is not completed.

Dependency of the operation performance and efficiency of neuromorphic processing units (NPUs) on the time length between NCTs or the definition of NCTs may be more definitely influenced in the case where the above example is extended and multiple NPUs are connected to exchange data with each other and process the data, and then X is to be increased.

When an n-th neuromorphic processing unit, among the neuromorphic processing units (NPUs) connected to each other, is represented by an NPUn, it may be assumed that, when NCT=T+1, NPU0 processes data received depending on the result of data processing in neuromorphic hardware when NCT=T, and transmits the processed data to NPU1 through the data output buffer and data transmission. In this case, it may be assumed that NPU1 receives data from NPU0, either depending on the result of data processing when NCT=T or when NCT=T+1, processes the received data when the data input buffer is not empty, and transmits processed data to NPU2 through the data output buffer and data transmission. Further, it may be assumed that, similar to NPU1, NPU2 receives data from NPU1, either depending on the result of data processing when NCT=T, or when NCT=T+1, processes the data when the data input buffer is not empty, and transmits the data to another NPU through the data output buffer and data transmission.

In this case, X must be equal to the number of clocks required for a process in which NPU2 waits for NPU0 and NPU1 to process data, receives all data from NPU1, processes all of the input data, and thereafter transmits result data to a NPU, corresponding to an output destination, or to a module in neuromorphic hardware and in which the output destination or the module completes reception of the transmitted data. If N/F is not sufficient, NPU0, NPU1 or NPU2 is not normally operated, and thus the neuromorphic hardware cannot normally perform data processing in the cases where NCT≥T+1. In contrast, when N is excessively large, great loss may be caused from the standpoint of efficiency such as time and power.

The NPU synchronization apparatus according to an embodiment may provide a method for efficiently managing and determining the time length X between variable neural-network clock ticks (NCTs).

Further, when data processing within a single neural-network clock tick (NCT) needs to be performed through sequential multi-step data processing and data exchange based on multiple neuromorphic processing units, the NPU synchronization apparatus according to an embodiment may provide a method for efficiently managing and determining the time length X between variable neural-network clock ticks (NCTs).

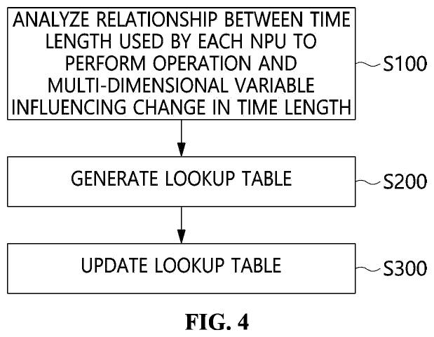

FIG. 4 is a flowchart illustrating a method for synchronizing neuromorphic processing units (NPUs) according to an embodiment of the present disclosure.

Referring to FIG. 4, an NPU synchronization apparatus according to an embodiment may analyze a relationship between a time length used by each neuromorphic processing unit (NPU) to perform an operation and a multi-dimensional variable influencing a change in the time length.

For this, the NPU synchronization apparatus according to the embodiment may calculate a time length for maximizing a likelihood probability distribution or a posterior probability distribution based on the time length used by each neuromorphic processing unit (NPU) to perform an operation and the multi-dimensional variable influencing the change in the time length at step S100.

The NPU synchronization apparatus according to the embodiment may generate a lookup table based on the multi-dimensional variable and the time length for maximizing the likelihood probability distribution or the posterior probability distribution for the multi-dimensional variable at step S200.

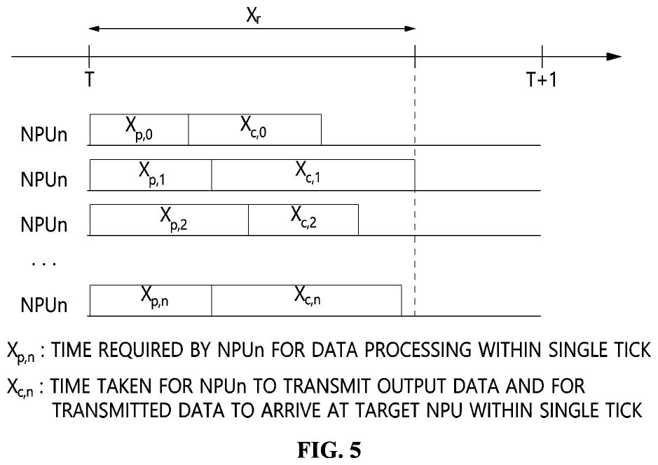

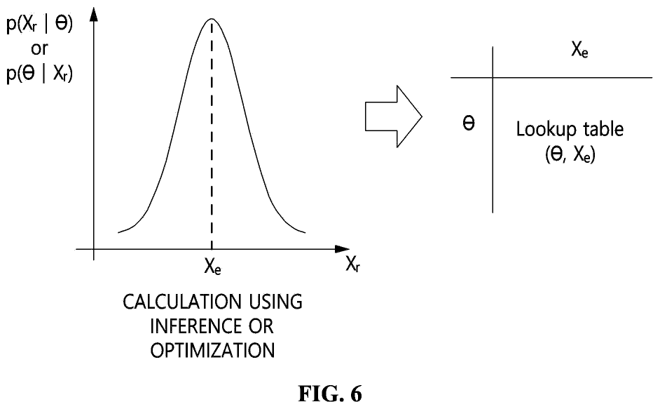

FIG. 5 is a diagram for explaining the time taken for all NPUs sharing an NCT with each other to complete data processing and exchange, which are to be completed within a single NCT, and FIG. 6 illustrates an example of the configuration of the lookup table of FIG. 5.

As illustrated in FIG. 5, the time length X between NCTs may be efficiently determined and managed.

The NPUs may share and use different time lengths X for respective ticks. The time length actually used by all NPUs which share the neural-network clock ticks (NCTs) to complete data processing and exchange, which are to be completely performed within a single NCT, may be represented by Xᵣ.

Because Xᵣ may be changed depending on the NPU state (e.g., the amount and structure of input data, neuron state variable values, a connection structure between NPUs, or the like), a data exchange method between NPUs, a policy, or the like, it may be handled as a variable.

In the case where Xᵣ is set to the variable, a set of all elements that may influence a change in X, may be represented by θ expressing a multi-dimensional variable. θ may include NPU state (e.g., the amount and structure of input data, neuron state variable values, a connection structure between NPUs, or the like), a data exchange method between NPUs, a policy, etc.

When a neuromorphic artificial neural network, a compiler, a neuromorphic hardware simulator, and neuromorphic hardware are given for the multi-dimensional variable θ and the time length Xᵣ, the values of the multi-dimensional variable θ and the time length Xᵣ and a relationship therebetween may be measured and analyzed through simulation or emulation, or actual execution of the components.

The analysis of the relationship between the multi-dimensional variable θ and the time length Xᵣ enables calculation of Xᵣ which maximizes a statistics technique, for example, a likelihood probability distribution p(Xᵣ|θ) or a posterior probability distribution p(θ|Xᵣ). For example, the analysis of the relationship may use inference or optimization based on linear/nonlinear programming, Markov chain Monte-Carlo (MCMC) methodology, Laplace approximation, regression analysis, a random process, an artificial neural network, gradient descent, a Newton method, and a Kalman filter, and derivation technologies thereof.

As illustrated in FIG. 6, Xᵣ which maximizes the likelihood probability distribution p(Xᵣ|θ) or the posterior probability distribution p(θ|Xᵣ) for 0 may be represented by Xₑ.

The NPU synchronization apparatus according to the embodiment may generate a lookup table in which Xₑ values are enumerated for the multi-dimensional variable θ. Here, the lookup table may be managed in the internal memory or external memory of the corresponding NPU. Further, in the lookup table, (θ, Xₑ) pairs may be stored, wherein θ may be a key and Xₑ may be a value.

An initial lookup table may be configured based on profiles measured through neuromorphic artificial neural network application simulation, compiling, and neuromorphic hardware simulation.

The lookup table may be updated in real time, periodically, or non-periodically depending on a computational load required for updating and the state of computing resources.

In order to update the lookup table, a statistics technique or a numerical technique that is capable of calculating Xₑ, which is Xᵣ for maximizing the likelihood probability distribution p(Xᵣ|θ) or the posterior probability distribution p(θ|Xᵣ) may be used. For example, inference or optimization may be used based on linear/nonlinear programming, Markov chain Monte-Carlo (MCMC) methodology, Laplace approximation, regression analysis, a random process, an artificial neural network, gradient descent, a Newton method, and a Kalman filter, and derivation technologies thereof.

When X and θ at NCT=T are represented by X(T) and θ(T), X(T) may be determined to be the value of Xₑ obtained when θ(T) in the lookup table is used as a key.

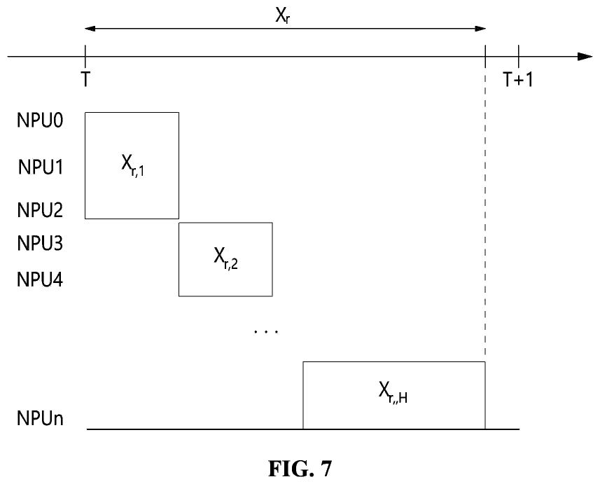

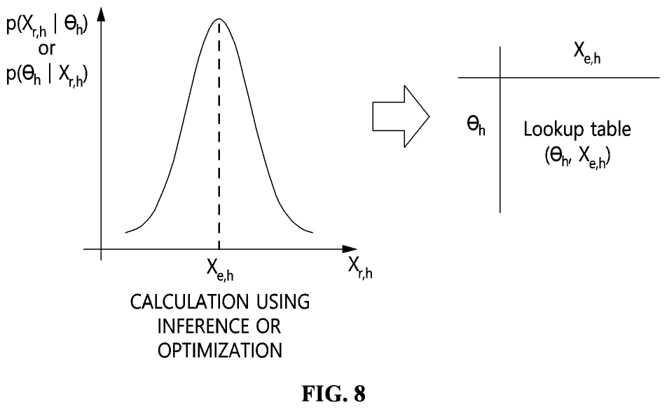

FIG. 7 is a diagram for explaining the time taken to complete data processing within a single NCT through sequential multi-step data processing and data exchange performed based on multiple NPUs according to another embodiment, and FIG. 8 illustrates an example of the configuration of the lookup table of FIG. 7.

As illustrated in FIG. 7, when data processing within a single NCT is to be performed through sequential multi-step data processing and data exchange based on multiple neuromorphic processing units (NPUs), a time length Xₕ(T) subdivided from X(T) may be used for the maximum sequential data processing step H (where H is a positive integer) determined at a compiling step and h (h∈{1,2,3, . . . , H}) for representing the sequential data processing step.

The time length actually used by all NPUs sharing the NCT to complete data processing and exchange, which are to be completed within a single NCT and at single step h, may be represented by X_{r.h}, and Xᵣ may be determined to be the sum of X_{r.h} values.

A set of all elements that may influence a change in X_{r.h} may be represented by a multi-dimensional variable θₕ.

As illustrated in FIG. 8, the time length X_{e.h} for maximizing a likelihood probability distribution p(X_{r.h}|θₕ) or a posterior probability distribution p(θₕ|X_{r.h}) may be calculated to analyze a relationship between θₕ and X_{r.h}.

The NPU synchronization apparatus according to an embodiment may generate a lookup table in which X_{e.h} values are enumerated for θₕ. That is, in the lookup table, (θₕ, X_{e.h}) pairs may be stored.

The initial lookup table may be configured based on profiles measured through neuromorphic artificial neural network application simulation, compiling, and neuromorphic hardware simulation.

Xₕ(T) may be determined to be the value of X_{e.h} when θₕ(T) is used as a key in the lookup table in which (θₕ, X_{e.h}) pairs are stored.

The lookup table may be updated in real time, periodically, or non-periodically depending on a computational load required for updating and the state of computing resources.

In order to update the lookup table, a statistics technique or a numerical technique that is capable of calculating X_{e.h}, which is the time length for maximizing the likelihood probability distribution p(X_{r.h}|θₕ) or the posterior probability distribution p(θₕ|X_{r.h}), may be used. For example, inference or optimization may be used based on linear/nonlinear programming, Markov chain Monte-Carlo (MCMC) methodology, Laplace approximation, regression analysis, a random process, an artificial neural network, gradient descent, a Newton method, and a Kalman filter, and derivation technologies thereof.

The lookup table including (θₕ, X_{e.h}) pairs may be managed together with the lookup table including (θ, Xₑ) pairs depending on the relationship between θ and θₕ (e.g., θₕ is a subset of θ).

When the lookup table including (θₕ, X_{e.h}) pairs needs to be separated from the lookup table including (θ, Xₑ) pairs, the lookup table including (θₕ, X_{e.h}) pairs may be managed in the internal or external memory of each NPU.

When Xₕ and θₕ at NCT=T are represented by Xₕ(T) and θₕ(T), θₕ(T) may be handled together with θ(T) at an initial sequential data processing step performed within T, and X(T) may be determined to be the sum of Xₕ(T) values.

Referring back to FIG. 4, each neuromorphic processing unit according to the embodiment may update the lookup tables including (θ, Xₑ) pairs or (θₕ, X_{e.h}) pairs at step S300.

The lookup tables including (θ, Xₑ) pairs or (θₕ, X_{e.h}) pairs may be constructed and updated through linear/nonlinear programming, Markov chain Monte-Carlo (MCMC) methodology, Laplace approximation, regression analysis, a random process, an artificial neural network, gradient descent, a Newton method, and a Kalman filter, and derivation technologies thereof.

The lookup tables including (θ, Xₑ) pairs or (θₕ, X_{e.h}) pairs may be constructed by utilizing profiles or data measured through neuromorphic artificial neural network application simulation, compiling, neuromorphic hardware simulation or neuromorphic hardware execution.

The lookup tables including (θ, Xₑ) pairs or (θₕ, X_{e.h}) pairs may be updated in real time, periodically or non-periodically based on data obtained by measuring the difference between (θₕ(T), X_{e.h}) and (θₕ(T), X_{r.h}(T)) or the difference between (θ(T), Xₑ) and (θ(T), Xᵣ (T)) during hardware simulation or hardware execution.

The NPU synchronization apparatus according to the embodiment may include a filter capable of determining the degree to which an error (a fault) that may occur during data processing and exchange can be endured, that is, a fault tolerant determination filter, when the difference between (θₕ(T), X_{e.h}) and (θₕ(T), X_{r.h}(T)) or the difference between (θ(T), Xₑ) and (θ(T), Xᵣ(T)) occurs. Here, the fault tolerant determination filter may be included in each NPU.

The determination condition to be used in the fault tolerant determination filter may be input from a developer or a user.

The NPU synchronization apparatus according to the embodiment may include an update reflection determination filter for determining whether or not the difference is to be reflected in the update of the lookup tables which store (θₕ, X_{e.h}) or (θ, Xₑ) pairs, when the difference between (θₕ(T), X_{e.h}) and (θₕ(T), X_{r.h}(T)) or the difference between (θ(T), Xₑ) and (θ(T), Xᵣ(T)) occurs. Here, the update reflection determination filter may be included in each NPU or may be provided outside the NPU.

The determination condition to be used by the update reflection determination filter may be input from a developer or a user.

In the case where the difference between (θₕ(T), X_{e.h}) and (θₕ(T), X_{r.h}(T)) or the difference between (θ(T), Xₑ) and (θ(T), Xᵣ (T)) occurs, if the difference is determined to be a fault that can be endured by the fault tolerant determination filter, data processing and exchange to be performed at step h or within a tick are completed in conformity with X_{e.h} or Xₑ, after which neuromorphic hardware simulation h, which is to be performed at sequential data processing step h+1 or within a tick T+1, may be performed through the execution of the neuromorphic hardware.

In the case where the difference between (θₕ(T), X_{e.h}) and (θₕ(T), X_{r.h}(T)) or the difference between (θ(T), Xₑ) and (θ(T), Xᵣ (T)) occurs, if the difference is determined to be a fault that cannot be endured by the fault tolerant determination filter, data processing and exchange are completed by temporally using Xᵣ h(T) or Xᵣ (T) instead of Xₕ(T) or X(T) that was previously designated to be used, after which sequential data processing step h or a tick T proceeds to h+1 or T+1, whereby hardware simulation or hardware execution may be performed.

In the case where the difference between (θₕ(T), X_{e.h}) and (θₕ(T), X_{r.h}(T)) or the difference between (θ(T), Xₑ) and (θ(T), Xᵣ(T)) occurs, if it is determined by the lookup table update reflection determination filter that the difference needs to be reflected in the update of the lookup tables, the difference may be added to data that is to be used to update the lookup tables managed in the internal memory or the external memory of each NPU.

In the case where the difference between (θₕ(T), X_{e.h}) and (θₕ(T), X_{r.h}(T)) or the difference between (θ(T), Xₑ) and (θ(T), Xᵣ (T)) occurs, if it is determined by the lookup table update reflection determination filter that the difference does not need to be reflected in the update of the lookup tables, the difference may be ignored.

The NPU synchronization apparatus according to an embodiment may be implemented in a computer system, such as a computer-readable storage medium.

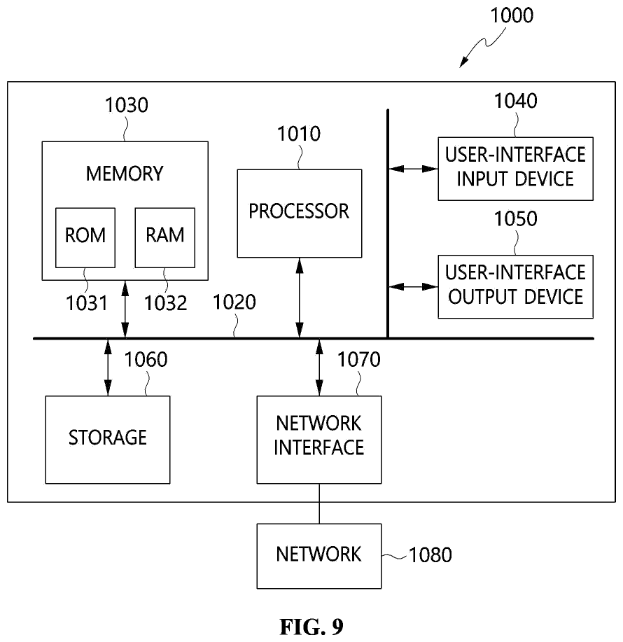

FIG. 9 is a block diagram illustrating the configuration of a computer system according to an embodiment.

Referring to FIG. 9, a computer system 1000 according to an embodiment may include one or more processors 1010, memory 1030, a user interface input device 1040, a user interface output device 1050, and storage 1060, which communicate with each other through a bus 1020. The computer system 1000 may further include a network interface 1070 connected to a network 1080.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the NPU synchronization apparatus.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an application-specific integrated circuit (ASIC), a field-programmable gate array (FPGA), etc., without being limited thereto.

The memory 1030 may store various types of data for the overall operation such as a control program for performing the NPU synchronization method according to the embodiment. In detail, the memory 1030 may store multiple applications executed by the NPU synchronization apparatus, and data and instructions for the operation of the NPU synchronization apparatus.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

In accordance with an embodiment, a computer-readable storage medium for storing a computer program may include instructions enabling the processor to perform a method including an operation of calculating a time length maximizing a likelihood probability distribution or a posterior probability distribution based on a multi-dimensional variable influencing a change in a time length used by a neuromorphic processing unit (NPU) to perform an operation, an operation of generating a lookup table based on the multi-dimensional variable and the time length maximizing the likelihood probability distribution or the posterior probability distribution for the multi-dimensional variable, and an operation of updating the lookup table based on the time length used by the neuromorphic processing unit to perform the operation and the time length maximizing the likelihood probability distribution or the posterior probability distribution.

In accordance with an embodiment, a computer program stored in a computer-readable storage medium may include instructions enabling the processor to perform a method including an operation of calculating a time length maximizing a likelihood probability distribution or a posterior probability distribution based on a multi-dimensional variable influencing a change in a time length used by a neuromorphic processing unit (NPU) to perform an operation, an operation of generating a lookup table based on the multi-dimensional variable and the time length maximizing the likelihood probability distribution or the posterior probability distribution for the multi-dimensional variable, and an operation of updating the lookup table based on the time length used by the neuromorphic processing unit to perform the operation and the time length maximizing the likelihood probability distribution or the posterior probability distribution.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

In accordance with the present disclosure, advantages may be obtained from the standpoint of operation time and power efficiency by optimizing the operation of a neuromorphic processing unit.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A method for synchronizing neuromorphic processing units, comprising:
calculating a time length maximizing a likelihood probability distribution or a posterior probability distribution based on a multi-dimensional variable influencing a change in a time length used by a neuromorphic processing unit to perform an operation;
generating a lookup table based on the multi-dimensional variable and the time length maximizing the likelihood probability distribution or the posterior probability distribution for the multi-dimensional variable; and
updating the lookup table based on the time length used by the neuromorphic processing unit to perform the operation and the time length maximizing the likelihood probability distribution or the posterior probability distribution.

2. The method of claim 1, wherein the lookup table includes (θ, Xₑ) pairs formed using a multi-dimensional variable (θ) influencing a change in a time length (Xᵣ) used by the neuromorphic processing unit to complete data processing and exchange and a time length (Xₑ) maximizing a likelihood probability distribution or a posterior probability distribution for the multi-dimensional variable (θ).

3. The method of claim 2, wherein the lookup table includes (θₕ, X_{e,h}) pairs formed using a multi-dimensional variable (θₕ) influencing changes in respective time lengths (X_{r,h}) used by multiple neuromorphic processing units to complete sequential multi-step data processing and data exchange and a time length (X_{e,h}) maximizing a likelihood probability distribution or a posterior probability distribution for the multi-dimensional variable (θₕ).

4. The method of claim 3, wherein the time length used by the neuromorphic processing unit to perform the operation is determined to be a sum of respective time lengths (Xᵣ,h) used by the multiple neuromorphic processing units to complete sequential multi-step data processing and data exchange.

5. The method of claim 3, wherein the lookup table comprises a first lookup table including the (θ, Xₑ) pairs and a second lookup table including the (θₕ, X_{e,h}) pairs, and the first and second lookup tables are individually managed by an internal memory or an external memory of each neuromorphic processing unit.

6. The method of claim 1, wherein the lookup table is constructed and updated based on at least one of linear/nonlinear programming, Markov chain Monte-Carlo (MCMC) methodology, Laplace approximation, regression analysis, a random process, an artificial neural network, gradient descent, a Newton method or a Kalman filter, or a combination thereof.

7. The method of claim 1, wherein whether the lookup table is to be updated is determined based on a difference between the time length used by the neuromorphic processing unit to perform the operation and the time length maximizing the likelihood probability distribution or the posterior probability distribution.

8. The method of claim 1, wherein the multi-dimensional variable includes at least one of state information of the neuromorphic processing unit, a method for exchanging data between neuromorphic processing units, or a policy, or a combination thereof.

9. The method of claim 8, wherein the state information of the neuromorphic processing unit includes at least one of an amount and a structure of input data, a neuron state variable value or information about a connection structure between neuromorphic processing units, or a combination thereof.

10. An apparatus for synchronizing neuromorphic processing units, comprising:
a memory configured to store a control program for synchronizing neuromorphic processing units; and
a processor configured to execute the control program stored in the memory,
wherein the processor is configured to calculate a time length maximizing a likelihood probability distribution or a posterior probability distribution based on a multi-dimensional variable influencing a change in a time length used by a neuromorphic processing unit to perform an operation, generate a lookup table based on the multi-dimensional variable and the time length maximizing the likelihood probability distribution or the posterior probability distribution for the multi-dimensional variable, and update the lookup table based on the time length used by the neuromorphic processing unit to perform the operation and the time length maximizing the likelihood probability distribution or the posterior probability distribution.

11. The apparatus of claim 10, wherein the processor performs control such that (θ, Xₑ) pairs formed using a multi-dimensional variable (θ) influencing a change in a time length (Xᵣ) used by the neuromorphic processing unit to complete data processing and exchange and a time length (Xₑ) maximizing a likelihood probability distribution or a posterior probability distribution for the multi-dimensional variable (θ) are stored in the lookup table.

12. The apparatus of claim 11, wherein the processor performs control such that (θₕ, X_{e,h}) pairs formed using a multi-dimensional variable (θₕ) influencing changes in respective time lengths (X_{r,h}) used by multiple neuromorphic processing units to complete sequential multi-step data processing and data exchange and a time length (X_{e,h}) maximizing a likelihood probability distribution or a posterior probability distribution for the multi-dimensional variable (θₕ) are stored in the lookup table.

13. The apparatus of claim 12, wherein the time length used by the neuromorphic processing unit to perform the operation is determined to be a sum of respective time lengths (X_{r,h}) used by the multiple neuromorphic processing units to complete sequential multi-step data processing and data exchange.

14. The apparatus of claim 12, wherein the lookup table comprises a first lookup table including the (θ, Xₑ) pairs and a second lookup table including the (θₕ, X_{e,h}) pairs, and the first and second lookup tables are individually managed by an internal memory or an external memory of each neuromorphic processing unit.

15. The apparatus of claim 10, wherein the processor performs control such that the lookup table is constructed and updated based on at least one of linear/nonlinear programming, Markov chain Monte-Carlo (MCMC) methodology, Laplace approximation, regression analysis, a random process, an artificial neural network, gradient descent, a Newton method or a Kalman filter, or a combination thereof.

16. The apparatus of claim 10, wherein the processor determines whether the lookup table is to be updated based on a difference between the time length used by the neuromorphic processing unit to perform the operation and the time length maximizing the likelihood probability distribution or the posterior probability distribution.

17. The apparatus of claim 10, wherein the multi-dimensional variable includes at least one of state information and a structure of the neuromorphic processing unit, a method for exchanging data between neuromorphic processing units, or a policy, or a combination thereof.

18. The apparatus of claim 17, wherein the state information of the neuromorphic processing unit includes at least one of an amount of input data, a neuron state variable value or information about a connection structure between neuromorphic processing units, or a combination thereof.
